(19) United States
(12) Patent Application Publication
(10) Pub. No.: US 2023/0059658 A1
(43) Pub. Date: Feb. 23, 2023

(54) SCHEDULING IN WIRELESS COMMUNICATION NETWORKS

(71) Applicant: Nokia Technologies Oy, Espoo (FI)

(72) Inventors: Stepan KUCERA, Munich (DE); Federico CHIARIOTTI, Mestre (IT); Andrea ZANELLA, Cadoneghe (IT)

(21) Appl. No.: 17/796,200

(22) PCT Filed: Dec. 30, 2020
(86) PCT No.: PCT/EP2020/088037

§ 371 Date: Jul. 28, 2022

(30) Foreign Application Priority Data
Feb. 3, 2020 (FI) 20205110

(51) Int. Cl. H04W 72/08; H04W 76/20; H04W 76/15

(52) U.S. Cl. CPC H04W 72/085; H04W 76/20; H04W 76/15

(57) ABSTRACT

This document describes scheduling in wireless communication networks. According to an aspect, a method comprises: receiving a data block to be transmitted to a receiver apparatus via multiple link paths; associating a quality of service requirement with the data block; determining performance of each of the multiple link paths; encoding redundancy information from the data block and scaling an amount of the redundancy information based at least partially on the quality of service requirement and the determined performances; organizing, based at least partially on the quality of service requirement and the determined performances, the data block and the redundancy information to the multiple link paths; and transmitting the data block and the redundancy information to the receiver apparatus via the multiple link paths.

### FIELD

Various example embodiments relate to scheduling in wireless communication networks.

### BACKGROUND

In the field of wireless communications, scheduling may be used for improving data transmission in a channel. It might be beneficial to provide solutions enhancing the scheduling.

### BRIEF DESCRIPTION

According to an aspect, there is provided the subject matter of independent claims. Dependent claims define some embodiments.

According to an aspect, there is provided an apparatus comprising means for performing: receiving a data block to be transmitted to a receiver apparatus via multiple link paths; associating a quality of service requirement with the data block; determining performance of each of the multiple link paths; encoding redundancy information from the data block; generating a transmission schedule for the data block by organizing, based at least partially on the quality of service requirement and the determined performances, the data block and the redundancy information to the multiple link paths; estimating, on the basis of the performances, a success probability for delivering the data block successfully to the data sink by using the transmission schedule; comparing the success probability with a threshold and, upon determining on the basis of the comparison that the success probability is not high enough, generating a new transmission schedule for the data block with a greater amount of redundancy information; and upon determining on the basis of the comparison that the success probability is high enough, transmitting the data block and the redundancy information corresponding to the transmission schedule that meets the high-enough success probability to the receiver apparatus via the multiple link paths.

In an embodiment, the means are configured to iterate said generating, estimating, and comparing until the transmission schedule that meets the high-enough success probability is found, wherein the amount of redundancy information in the transmission schedule is increased with every iteration.

In an embodiment, the quality of service requirement is a reliability requirement defining a minimum success probability for delivering the data block successfully to the receiver apparatus, and wherein the threshold is the minimum success probability.

In an embodiment, the means are configured to optimize a size of the data block by performing the following: initializing a value of the size of the data block; generating, on the basis of the value of the size of the data block, the transmission schedule for the data block by organizing the data block and the redundancy information to the link paths up to the maximum capacity of each link path; performing said estimating the success probability and said comparing and, in response to finding that the transmission schedule meets the high-enough success probability, increasing the size of the data block and re-iterating said generating, estimating the success probability, and comparing until the transmission schedule that meets the high-enough success probability is not found; in response to not finding the transmission schedule that meets the high-enough success probability, decreasing the size of the data block and re-iterating said generating, estimating, and comparing until the transmission schedule that meets the high-enough success probability is found; and upon finding a maximum value of the size of the data block that provides the high-enough success probability, using the corresponding transmission schedule in said transmitting.

In an embodiment, the means are configured to optimize latency of the data block by performing the following: initializing a value of the latency requirement; estimating, on the basis of the performances and the value of the latency requirement, a maximum capacity of each link path; generating the transmission schedule for the data block by organizing the data block and the redundancy information to the link paths up to the maximum capacity of each link path; performing said estimating the success probability and said comparing and, in response to finding that the transmission schedule meets the high-enough success probability, increasing the value of the latency requirement and re-iterating said estimating the maximum capacity, generating, estimating the success probability, and comparing until the transmission schedule that meets the high-enough success probability is not found; in response to not finding the transmission schedule that meets the high-enough success probability, decreasing the value of the latency requirement and re-iterating said estimating the maximum capacity, generating, estimating the success probability, and comparing until the transmission schedule that meets the high-enough success probability is found; and upon finding a maximum value of the latency requirement that provides the high-enough success probability, using the corresponding transmission schedule in said transmitting.

In an embodiment, the means are configured to determine a stability limit for each link path, where said stability limit sets a maximum amount of data and/or redundancy information that can be organized in the link path to meet a link-path-specific latency requirement, to determine, per link path when generating the transmission schedule, whether or not the stability limit of a link path has been reached and, if the stability limit has been reached, prevent adding further redundancy information to the link path.

In an embodiment, the means are configured to redefine the quality-of-service requirement upon determining that the stability limit of all link path has been reached before finding a transmission schedule providing high-enough success probability.

In an embodiment, the means are configured to jointly optimize a plurality of parameters comprising: a size of the data block, latency of the data block, and a reliability requirement for the data block by performing the following: defining a payoff function that is a function of the plurality of parameters; selecting values of the plurality of parameters that represent the smallest value of the payoff function and generating the transmission schedule for the data block by organizing, on the basis of the selected values of the plurality of parameter, the data block and the redundancy information to the link paths; performing said estimating the success probability and said comparing and, in response to finding that the transmission schedule meets the high-enough success probability, performing a re-selection where values of the plurality of parameters representing the next higher value of the payoff function are selected, and re-iterating said generating the transmission schedule, estimating the success probability, and comparing until the transmission schedule that meets the high-enough success probability is not found; and upon finding a maximum value of the payoff function that provides the high-enough success probability, using the corresponding transmission schedule in said transmitting.

In an embodiment, the means comprise: at least one processor; and

at least one memory including computer program code, said at least one memory and computer program code being configured to, with said at least one processor, cause the performance of the apparatus.

According to an aspect, there is provided a method comprising: receiving, by a network node, a data block to be transmitted to a receiver apparatus via multiple link paths; associating, by the network node, a quality of service requirement with the data block; determining, by the network node, performance of each of the multiple link paths; encoding, by the network node, redundancy information from the data block; generating, by the network node, a transmission schedule for the data block by organizing, based at least partially on the quality of service requirement and the determined performances, the data block and the redundancy information to the multiple link paths; estimating, by the network node on the basis of the performances, a success probability for delivering the data block successfully to the data sink by using the transmission schedule; comparing, by the network node, the success probability with a threshold and, upon determining on the basis of the comparison that the success probability is not high enough, generating a new transmission schedule for the data block with a greater amount of redundancy information; and upon determining, by the network node on the basis of the comparison that the success probability is high enough, transmitting the data block and the redundancy information corresponding to the transmission schedule that meets the high-enough success probability to the receiver apparatus via the multiple link paths.

In an embodiment, the network node iterates said generating, estimating, and comparing until the transmission schedule that meets the high-enough success probability is found, wherein the amount of redundancy information in the transmission schedule is increased with every iteration.

In an embodiment, the quality of service requirement is a reliability requirement defining a minimum success probability for delivering the data block successfully to the receiver apparatus, and wherein the threshold is the minimum success probability.

In an embodiment, the network node optimizes a size of the data block by performing the following: initializing a value of the size of the data block; generating, on the basis of the value of the size of the data block, the transmission schedule for the data block by organizing the data block and the redundancy information to the link paths up to the maximum capacity of each link path; performing said estimating the success probability and said comparing and, in response to finding that the transmission schedule meets the high-enough success probability, increasing the size of the data block and re-iterating said generating, estimating the success probability, and comparing until the transmission schedule that meets the high-enough success probability is not found; in response to not finding the transmission schedule that meets the high-enough success probability, decreasing the size of the data block and re-iterating said generating, estimating, and comparing until the transmission schedule that meets the high-enough success probability is found; and upon finding a maximum value of the size of the data block that provides the high-enough success probability, using the corresponding transmission schedule in said transmitting.

In an embodiment, the network node optimizes latency of the data block by performing the following: initializing a value of the latency requirement; estimating, on the basis of the performances and the value of the latency requirement, a maximum capacity of each link path; generating the transmission schedule for the data block by organizing the data block and the redundancy information to the link paths up to the maximum capacity of each link path; performing said estimating the success probability and said comparing and, in response to finding that the transmission schedule meets the high-enough success probability, increasing the value of the latency requirement and re-iterating said estimating the maximum capacity, generating, estimating the success probability, and comparing until the transmission schedule that meets the high-enough success probability is not found; in response to not finding the transmission schedule that meets the high-enough success probability, decreasing the value of the latency requirement and re-iterating said estimating the maximum capacity, generating, estimating the success probability, and comparing until the transmission schedule that meets the high-enough success probability is found; and upon finding a maximum value of the latency requirement that provides the high-enough success probability, using the corresponding transmission schedule in said transmitting.

In an embodiment, the network node determines a stability limit for each link path, where said stability limit sets a maximum amount of data and/or redundancy information that can be organized in the link path to meet a link-path-specific latency requirement, determines per link path when generating the transmission schedule whether or not the stability limit of a link path has been reached and, if the stability limit has been reached, prevents adding further redundancy information to the link path.

In an embodiment, the network node redefines the quality-of-service requirement upon determining that the stability limit of all link path has been reached before finding a transmission schedule providing high-enough success probability.

In an embodiment, the network node jointly optimize a plurality of parameters comprising: a size of the data block, latency of the data block, and a reliability requirement for the data block by performing the following: defining a payoff function that is a function of the plurality of parameters; selecting values of the plurality of parameters that represent the smallest value of the payoff function and generating the transmission schedule for the data block by organizing, on the basis of the selected values of the plurality of parameter, the data block and the redundancy information to the link paths; performing said estimating the success probability and said comparing and, in response to finding that the transmission schedule meets the high-enough success probability, performing a re-selection where values of the plurality of parameters representing the next higher value of the payoff function are selected, and re-iterating said generating the transmission schedule, estimating the success probability, and comparing until the transmission schedule that meets the high-enough success probability is not found; and upon finding a maximum value of the payoff function that provides the high-enough success probability, using the corresponding transmission schedule in said transmitting.

According to another aspect, there is provided a computer program product embodied on a computer-readable distribution medium and comprising computer program instructions that, when executed by a computer, cause the computer to carry out a computer process in a network node, the computer process comprising: receiving a data block to be transmitted to a receiver apparatus via multiple link paths; associating a quality of service requirement with the data block; determining performance of each of the multiple link paths; encoding redundancy information from the data block; generating a transmission schedule for the data block by organizing, based at least partially on the quality of service requirement and the determined performances, the data block and the redundancy information to the multiple link paths; estimating, on the basis of the performances, a success probability for delivering the data block successfully to the data sink by using the transmission schedule; comparing the success probability with a threshold and, upon determining on the basis of the comparison that the success probability is not high enough, generating a new transmission schedule for the data block with a greater amount of redundancy information; and upon determining on the basis of the comparison that the success probability is high enough, transmitting the data block and the redundancy information corresponding to the transmission schedule that meets the high-enough success probability to the receiver apparatus via the multiple link paths.

One or more examples of implementations are set forth in more detail in the accompanying drawings and the description of embodiments.

### LIST OF DRAWINGS

Some embodiments will now be described with reference to the accompanying drawings, in which

FIG. 1 illustrates an example of a wireless network to which embodiments of the invention may be applied;

FIG. 2 illustrates a multi-connectivity scenario for a terminal device;

FIG. 3 illustrates an embodiment for data transmission in a multi-connectivity scenario;

FIG. 4 illustrates an embodiment for iterative evaluation of delivery probability.

FIG. 5 illustrates an embodiment for finding stability limits for a set of data delivery paths.

FIG. 6 illustrates an embodiment for finding the set of possible data delivery instances.

FIG. 7 illustrates an embodiment for finding the optimum block size.

FIG. 8 illustrates an embodiment for finding the optimum latency.

FIG. 9 illustrates an embodiment for finding the optimum for multiple parameters.

FIG. 10 illustrates an embodiment for finding the latency and/or capacity.

FIGS. 11 to 12 illustrate apparatuses according to some embodiments.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the example embodiments and in the claims, serve to illustrate the embodiments with reference to the drawings, without limiting it to these examples only.

The embodiments and features, if any, disclosed in the following description that do not fall under the scope of the independent claims are to be interpreted as examples useful for understanding various embodiments of the invention.

In the following, different exemplifying embodiments will be described using, as an example of an access architecture to which the embodiments may be applied, a radio access architecture based on long term evolution advanced (LTE Advanced, LTE-A) or new radio (NR) (or can be referred to as 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or Wi-Fi), worldwide interoperability for microwave access (WiMAX), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node 104 (such as (e/g)NodeB) providing the cell. The link from a user device to a (e/g)NodeB is called uplink (UL) or reverse link and the physical link from the (e/g)NodeB to the user device is called downlink or forward link. The links may comprise a physical link. It should be appreciated that (e/g)NodeBs or their functionalities may be implemented by using any node, host, server or access point etc. entity suitable for such a usage. Said node 104 may be referred to as network node 104 or network element 104 in a broader sense.

A communications system typically comprises more than one (e/g)NodeB in which case the (e/g)NodeBs may also be configured to communicate with one another over links, wired or wireless, designed for the purpose. These links are sometimes called backhaul links that may be used for signaling purposes. The Xn interface is an example of such a link. The (e/g)NodeB is a computing device configured to control the radio resources of communication system it is coupled to. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements also referred to as antenna panels and transmission and reception points (TRP). The (e/g)NodeB is further connected to the core network 110 (CN or next generation core NGC). Depending on the system, the counterpart on the CN side can be a user plane function (UPF) (this may be 5G gateway corresponding to serving gateway (S-GW) of 4G) or access and mobility function (AMF) (this may correspond to mobile management entity (MME) of 4G).

The user device 100, 102 (also called UE, user equipment, user terminal, terminal device, mobile terminal, etc.) illustrates one type of an apparatus to which resources on the air interface are allocated and assigned, and thus any feature described herein with a user device may be implemented with a corresponding apparatus, such as a part of a relay node. An example of such a relay node is an integrated access and backhaul (IAB)-node (a.k.a. self-backhauling relay).

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink-only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments mobile terminal (MT) part of the relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices may have one or more antennas. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and operability in different radio bands such as below 6 GHz-cmWave, below 6 GHz-cmWave-mmWave. One of the concepts considered to be used in 5G networks is network slicing in which multiple independent and dedicated virtual sub-networks (network instances) may be created within the same infrastructure to run services that have different requirements on latency, reliability, throughput and mobility.

The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side and non-real time functions being carried out in a centralized manner.

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

A technical challenge related to 5G standardization as well as in real-time streaming of video/augmented reality (AR)/virtual reality (VR) content might be the delivery of data under strict end-to-end throughput, latency and reliability constraints. For example, in Industry 4.0 applications, a 5G network must deliver robot control message within the control loop cycle, otherwise an alert is triggered and production interrupted. In video streaming, each video frame must be delivered and displayed to the end user within the frame display time defined during video recording to ensure a smooth and natural replay. Throughput, latency and reliability guarantees in wireless communications may be achieved by using multiple parallel link paths. These link paths can be 5G NR (New Radio) or 5G and 4G links. If one link path fails, other link path(s) seamlessly back it up to ensure reliable end-to-end data delivery within a pre-defined deadline as required in the above-mentioned frameworks. Yet to deliver a data flow with strict latency and reliability constraints over multiple link paths, it may be beneficial for a so-called multi-path scheduler to know the link path capacity, end-to-end latency as well as buffer occupancy. These parameters however may fluctuate over time in an unpredictable manner due to adverse phenomena at every layer of the protocol stack for example poor coverage, multi-user contention/congestion, receiver-to-sender feedback delay, biased probing and buffer overflows. Current technology may be single-path nature and even in multi-path mode does not offer any notion of data delivery reliability or QoS guarantees. Only best effort services are possible for any communication mode: the delivery time is as random and unpredictable as link path capacity itself.

FEC (forward-error correction) data may be used as an add-on to payload data flows that is meant to improve latency in the sense that dropped data may not need to be re-transmitted thanks to recovery from FEC redundancy. However, this may be done at the expense of reduced goodput of payload data as FEC is occupying usable network bandwidth. The non-optimized use of FEC may result in unreliable communications with better latency and possibly reduced throughput. When transmitting data over any link path, the fundamentally cumulative nature of queuing delay implies that the tail packets of a transmitted data block (e.g. a video frame) are less likely to be delivered within a pre-defined deadline (e.g. the required display time of the video frame). This may mean that the higher is the throughput, the lower is the probability/reliability to satisfy some pre-defined latency constraints. The degradation of end-to-end latency and reliability due to congestion and capacity variations of wireless link paths can be reversed by replacing/complementing payload packets with redundant FEC. This may enable the possibility of balancing the throughput/latency/reliability performance of a data flow in a controlled and deterministic manner. This insight may be used for achieving pre-defined performance targets within the physical network capacity limits and in that way may solve the problem of reliable user-centric communications.

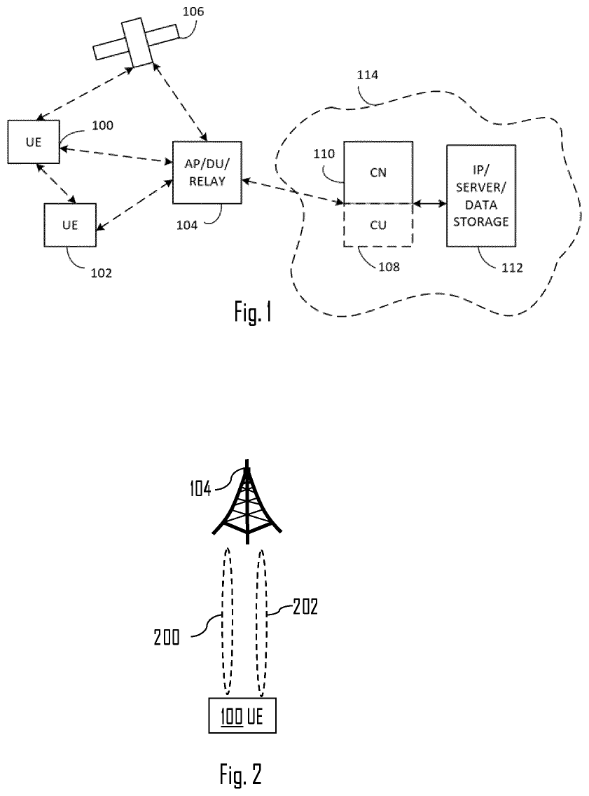

FIG. 2 illustrates a scenario where the multipath transmission scheduling is used between a single access node 104 and the UE 100. Multiple link paths 200, 202 may be configured between the access node 104 and the UE. The link paths 200, 202 may be configured, for example, with different beamforming configurations to provide spatial diversity for the duplication. Another type of diversity may be used as well. The scenario can also be applied to uplink communications as well as to multicast data delivery. The multipath scenario may be established for the UE 100 also via multiple access nodes via dual connectivity or multi-connectivity specified in 3GPP specifications. In the multi-connectivity scenario, there is a network node (e.g. in the radio access network or in the core network) operating a packet data convergence protocol (PDCP) layer, for example, that communicates with the PDCP layer of the UE 100 via multiple link paths established via different access nodes operating protocol layers below the PDCP layer. The PDCP layer in a data source may distribute or schedule payload data packets of an application to the multiple link paths according to a logic, while the PDCP layer at a data sink collects the data packets from the multiple link paths and aggregates the data packets.

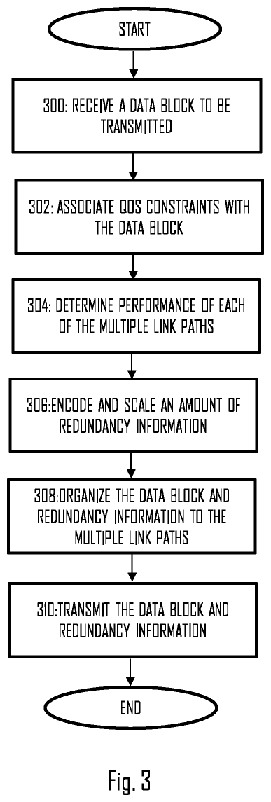

FIG. 3 illustrates a scenario where the multipath schedule optimization may be used. In this scenario, a data source (a transmitter) transmits a data block to a data sink (a receiver) via multiple link paths 200, 202. The data block may be received from an application server via a transport layer in a downlink scenario, or from an application executed in the UE in an uplink scenario. After receiving the data block (block 300), the data block may be stored in a send buffer, and QoS (Quality of Service) requirements are associated with the data block (block 302). Then, the performance of each of the multiple link paths is determined (block 304). The individual link paths can be enabled by using any technology for landline/wireless communications such as LTE, 5G NR, Wifi and Wigig. After determining the performance, redundancy information is encoded from the data block and an amount of the redundancy information is scaled based at least partially on the quality of service requirements and the determined link path performances (block 306). After this, the data block and the redundancy information is organized to the multiple link paths (block 308) and the data block and the redundancy information is transmitted based on thus created transmission schedule to the data sink (the receiver) (block 310).

The embodiment of FIG. 3 may be executed in the UE, in the access node, or in another network node of the cellular communication system that controls data transmissions via the multiple link paths. An example of such a network node is a translator device that can be implemented as a transport-layer proxy, but implementations on other layers of the OSI (Open System Interconnection) protocol stack are possible too (for example, medium access layer and network layer). Such a network-side proxy can be hosted by a hybrid access gateway, deployed for example in a User Plane Function module of a converged 5G core. The client-side proxy can be hosted either by an enterprise/residential gateway or in the UE. Let us call the apparatus executing the process of FIG. 3 or any one of its embodiments a scheduler in the description below.

As described above, adding the redundancy information improves the probability of delivering the data block successfully to the data sink within the QoS requirements. However, excessive amounts of redundancy information results in sub-optimal spectral efficiency. Therefore, capability of scaling the amount of the redundancy information is advantageous from the perspective of meeting the QoS requirements and also from the perspective of the overall system performance.

In an embodiment, block 308 is performed by organizing further redundancy information to the multiple link paths until it is determined that the amount of organized redundancy is sufficient for meeting the QoS requirements. This may be determined by estimating a success probability for delivering the data block successfully to the data sink, wherein the success probability is a function of the amount of redundancy information and link performances.

In an embodiment, the data block is partitioned into a plurality of packets, and the plurality of packets are organized into the multiple link paths, together with the associated redundancy information, based at least partially on the quality of service requirement and the determined performances. The packets may include packets that carry payload data and packets that carry the redundant information. In some embodiments, the data block is encoded into packets that each carry the data and the redundant information encoded together. The partitioning enables more efficient organizing to the multiple link paths because different link paths may have different link performances, e.g. different capabilities to deliver data. The partitioning enables more efficient adaptation to the varying link performances when performing said organizing.

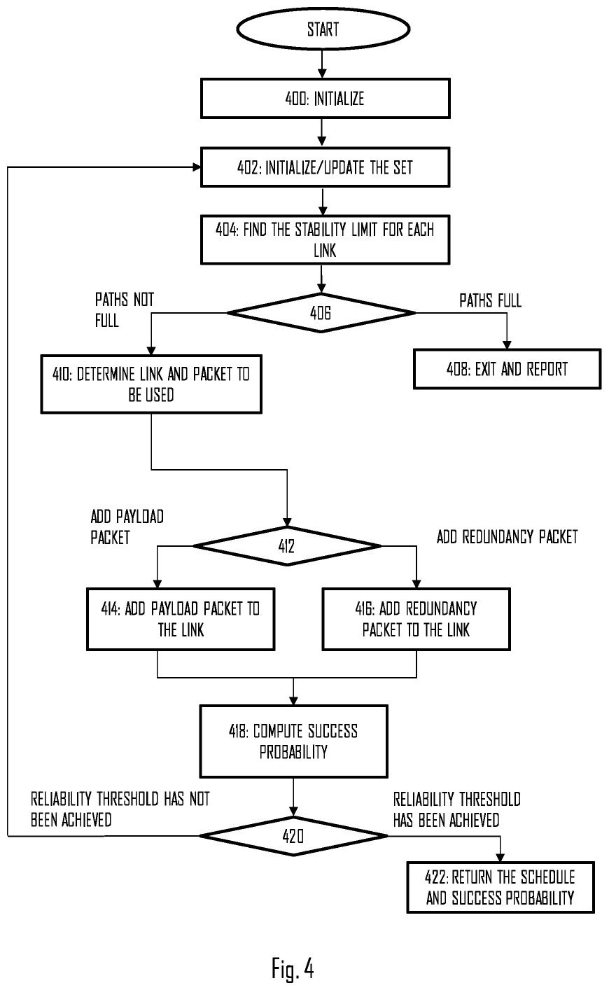

Referring to FIG. 4, an embodiment of the process of multipath schedule optimization comprises iterative generation of the schedule, from here onwards referred to as Algorithm 1. The first step in Algorithm 1 is to initialize (block 400) the required parameters. The parameters may include input parameters such the QoS requirements for a data block to be transmitted. The QoS requirements may be defined in terms of a reliability threshold R, a latency T indicating a deadline for time-of-arrival of the data block at the data sink, and the size K of the data block. The reliability R may define a minimum success probability for delivering a data block successfully to the data sink, and it can be defined by using certain reliability metrics such as a number of lost packets, a packet error rate, a bit error rate, etc. Further inputs may include information on the multiple link paths, the data block and the redundancy information generated from the data block, e.g. in the form of the FEC packets.

Then, a schedule s, a success probability P and a delivery set Dₖ(s) are initialized (block 402). The schedule s may be understood as a result of block 308, i.e. the distribution of the data block and the redundancy information into the multiple paths. The success probability P may indicate the probability of delivering the data block successfully to the data sink by using the schedule s. The delivery set Dk(s) may indicate all the possible scenarios for delivering the data block to the data sink by using the schedule s. Let us consider this with an overly simplified scenario where we have two link paths, and two data packets are established from the data block: a first data packet is the data block and a second data packet contains redundancy information generated from the data block. In order to successfully deliver the data block to the data sink, any one or both of the data packets must reach the data sink successfully. Let us consider that the schedule s is achieved by organizing the first data packet into a first link path and the second data packet into a second link path. Now, the delivery set Dk(s) includes: 1) only the first data packet reaching the data sink; 2) only the second data packet reaching the data sink; and 3) both data packets reaching the data sink successfully. These are the three scenarios for successfully delivering the data block from the data source to the data sink. By using the link performances, the success probability for each option can be computed, and the overall success probability for the data block being delivered to the data sink is a superposition of the three success probabilities.

Let us then return to FIG. 4. After the initialization, a stability limit rᵢ for each link path i is determined (block 404). The stability limit may be computed on the basis of the link performances, e.g. a data buffer status or a current end-to-end delay for the link path. If a link path cannot meet the QoS requirements, e.g. in terms of the latency, the link path may be considered to have reached its stability limit. In such a case, no further data of redundancy information is added to the link path. In a case that all the link paths are full (block 406), the process reports that the scheduling is not feasible under given QoS requirements (block 408). In such a case, the scheduler or the application may modify the QoS requirements. For example, some applications allow variable data rate services, e.g. some video applications where a video quality is reduced and, as a result, the QoS requirements may be loosened. After the adjustment of the QoS requirements, the process of FIG. 4 may be restarted for the data block.

Otherwise, the scheduler computes the probability of on-time (successful) delivery pᵢ(sᵢ+1,qᵢ) for the next scheduled packet on each link path that has not yet reached its stability limit. Then, the scheduler determines which link path has the highest pᵢ(sᵢ+1,qᵢ), among those paths that are not full. In other words, the link path providing the highest probability of on-time delivery for a packet may be selected. After the path has been chosen, a packet is scheduled to the chosen link path (block 410). First, the payload data packets K may be added to the link path (e.g. in the order as stored in the send buffer but any other order may be possible generally). If the reliability target R cannot be met with just payload packets K, then FEC packets are used (block 412). The scheduler may, however, equally use so-called rateless codes. After the payload packet (block 414) or a FEC packet (block 416) is added to the path, the scheduler finds the difference ΔD between the sets of favorable outcomes Dₖ(s) and Dₖ(s′) that haven't been evaluated yet. In other words, by considering the latest addition of the new packet, new delivery options for successfully delivering the data block become available, and ΔD defines the new delivery set with respect to the previous iteration. Then the scheduler computes the P (block 418) for the on-time delivery of the data block by evaluating a success probability to each delivery set and by summing the success probabilities of the delivery sets. The success probability for a delivery set may be computed on the basis of the observed link performance for each path. Each link path transfers data packets with certain characteristics that are defined in terms of packet loss rate, delivery time etc. On the basis of such information, a probability for delivering a data packet to the data sink within determined QoS constraints (R in this case) may be computed in a straightforward manner. By knowing the probability for transmitting a single data packet over a link path within R, the corresponding probability for the whole schedule d over the multiple link paths may then be computed in a straightforward manner.

After that, the scheduler can evaluate if P is smaller than R (block 420). In the case that P is smaller than R, the achievable reliability is not yet acceptable, and the process returns to block 402 for another iteration and addition of a new packet to the schedule. Accordingly, the schedule s′, the current success probability P, and the current delivery set Dₖ(s′) are updated (block 402). If P is greater than or equal to R, the scheduler returns the current schedule s and the current success probability P (block 422). It is possible that P of even the first packet achieves R and so s for the first packet is used. However, several iterations and additions of the packet containing the redundant information may be needed to achieve the reliability R defined by the QoS requirements. The redundant information may include parity check bits or other bits that enable decoding in the data sink in a case of bit or packet errors during the delivery of the packets.

The operation of the process of FIG. 4 may be understood on a general level such that the scheduler keeps organizing the packets into the multiple link paths until either the QoS requirements (R) are met (success) or that the link stability of all the link paths is reached (fail). Accordingly, the amount of redundant information is scaled according to the QoS requirements: more redundant information is scheduled for strict QoS requirements and less redundant information is scheduled for loose QoS requirements.

The procedure of FIG. 4 may be summarized as follows. According to an embodiment, the process comprises: receiving (as in block 300) a data block to be transmitted to a receiver apparatus via multiple link paths; associating (as in block 302) a quality of service requirement with the data block; determining (as in block 304) performance of each of the multiple link paths; encoding redundancy information from the data block; generating (blocks 412 to 416) a transmission schedule for the data block by organizing, based at least partially on the quality of service requirement and the determined performances, the data block and the redundancy information to the multiple link paths; estimating (block 418), on the basis of the performances, a success probability for delivering the data block successfully to the data sink by using the transmission schedule; comparing (block 420) the success probability with a threshold and, upon determining on the basis of the comparison that the success probability is not high enough, generating a new transmission schedule for the data block with a greater amount of redundancy information; and upon determining on the basis of the comparison that the success probability is high enough, transmitting the data block and the redundancy information corresponding to the transmission schedule that meets the high-enough success probability to the receiver apparatus via the multiple link paths.

As described above in connection with FIG. 4, said generating, estimating, and comparing steps are iterated until the transmission schedule that meets the high-enough success probability is found, wherein the amount of redundancy information in the transmission schedule is increased with every iteration.

Whether or not the success probability is high enough is determined by the threshold comparison in block 420. The threshold may be the minimum success probability or the reliability R.

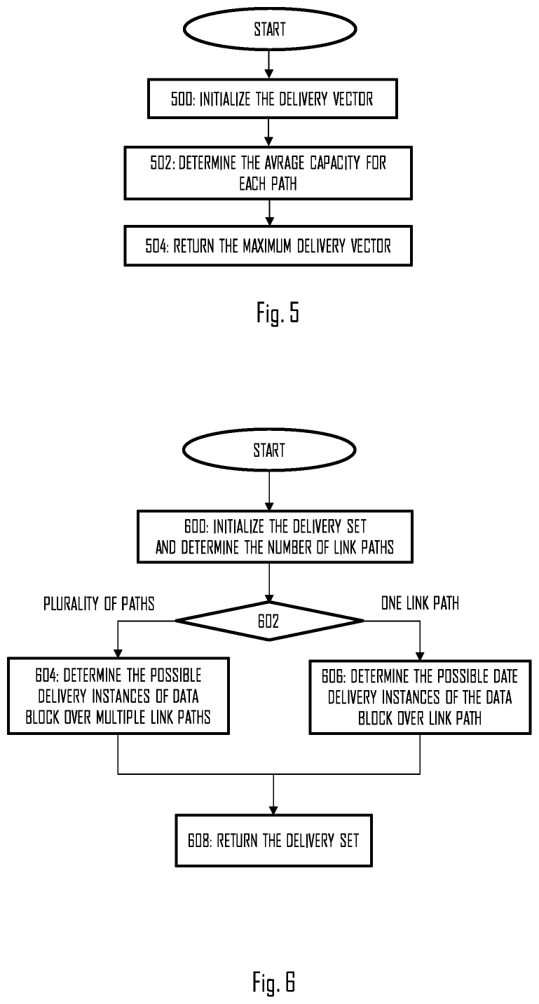

FIG. 5 illustrates an embodiment of block 404. Referring to FIG. 5, the scheduler may execute the process of FIG. 5 and acquire a maximum delivery vector r which describes a maximum number of packets that can be added to a link path. In block 404, if the link path readily has a number of packets equaling to the maximum delivery vector r, the link path has reached its stability limit. First, the scheduler initializes (block 500) the r. Then the scheduler determines (block 502) an average capacity Mᵢ on each link path i from a (Cumulative Distribution Function) CDF(Pᵢ(C), τi) where Pi(C) represents success probabilities and τi is the minimum round-trip time of the link path i. The scheduler then computes an average capacity for each link path Mᵢ, e.g. as: mean(Pi(C))+α*variance(Pi(C)). A may be a positive value. Then, the maximum delivery vector for the link path may be set to rᵢ==(T−τi/2)*Mᵢ−Wᵢ. T denotes a latency defined in the QoS requirements, i.e. a maximum latency allowed to the data block. After all link paths have been considered, the scheduler may return r (block 504).

FIG. 6 illustrates an embodiment for computing the delivery set Dk(s) for the data block. The process of FIG. 6 may be executed as a part of block 418. Referring to FIG. 6, the scheduler may find the delivery set by iterating over the available link paths and finding all possible delivery solutions that permit successful transmission of the data block to the data sink. Input parameters may include the block size K, the current schedule s, including the data of the data block and the redundant information. Accordingly, size of s is greater than K whenever redundant information is included in the schedule. First, the scheduler initializes the difference between delivery sets ΔD to an empty set and determines a number of currently available link paths (block 600). Scheduler then makes a decision (block 602) based on the number of the link paths. If there is only one link path, the possible solutions for delivering the data over the single link path is added to ΔD (block 606), and ΔD is returned to the main process of FIG. 4 (block 608). If there is a plurality of link paths, the scheduler goes through each link path and finds the possible solutions for delivering the data successfully over the link paths (block 604). Let us remind that there are typically multiple solutions for delivering the data over the multiple paths. For example, when a data packet is copied to two link paths, a successful delivery of the data packet may be achieved when one or both of the two link paths succeed in delivering the data packet to the data sink, thus providing a delivery set comprising three delivery solutions for the same schedule. The delivery set is then returned in block 608 for the computation of the success probability P for the delivery set. As described above, the success probability P may be computed from the success probabilities of each delivery set, and the success probability for each delivery set is then compared with the target QoS requirements.

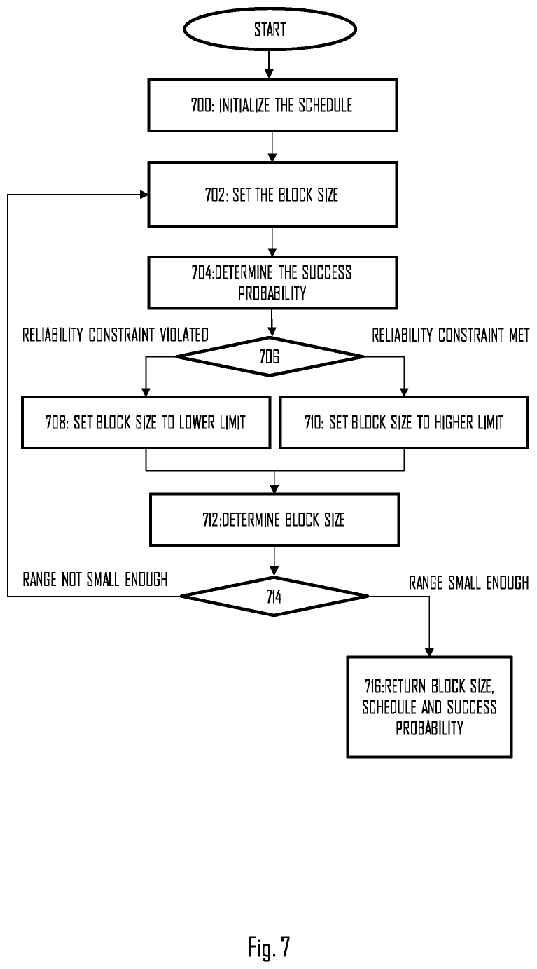

In the process of FIG. 4, the optimization of the schedule is carried out within the QoS requirement defining the reliability R for the delivery of the data block. The process of FIG. 4 may be utilized for other optimization problems as well. FIG. 7 illustrates an embodiment for using the process of FIG. 4 for optimizing the data block size K. Referring to FIG. 7, the scheduler may find the optimal block size K for a multipath schedule s. In an embodiment, the block size K is optimized within the QoS requirements defined in terms of latency T and reliability R. More specifically, the scheduler schedules as many payload packets (as large K) as possible while maintaining the reliability R latency T requirements. The scheduler may run the procedure of FIG. 4 for different values of payload data K until it finds the maximum value of K that satisfies the constraints. Since the reliability is monotonically decreasing as the block size K increases, it is possible to use a binary search. In binary search, the scheduler iteratively adapts parameters until it finds the optimal block size K. The scheduler starts the block size optimization with setting a data block minimum size Kₘᵢₙ to 0 and a data block maximum size Kₘₐₓ to the maximum delivery vector r, i.e. the maximum number of data packets that currently can be inserted into the link paths (see FIG. 5). Then, it initializes (block 700) the schedule s to an empty schedule and sets the success probability P to 0. After initializing, the scheduler sets (block 702) K to a value between the Kₘᵢₙ and the Kₘₐₓ, e.g. a mean value Using the said K value, the scheduler can determine the success probability P by running the process of FIG. 4. Based on the determined P, the scheduler makes a decision to set the Kₘᵢₙ or the Kₘₐₓ to the current block size K (block 706). If P is greater than or equal to R, the scheduler sets Kₘᵢₙ to K (block 708). In other words, a larger value of K can be used and still R can be reached. If P is smaller than R, the scheduler sets Kₘₐₓ to K (block 710). In other words, K was too large and needs to be decreased in order to meet R. After adjusting the limits, the scheduler may determine a new block size range K_{Δ} with the new value set [Kₘᵢₙ, Kₘₐₓ] (block 712). Then, the scheduler compares the block size range to a predetermined value and makes a decision (block 714). If the block size range K_{Δ} is greater than the predetermined value, the scheduler continues iterating by setting a new block size K to a value between the updated Kₘᵢₙ and Kₘₐₓ (block 702). If K_{Δ} is smaller than or equal to the predetermined value, the scheduler returns the current K and, optionally, s and P (block 716). The predetermined value may define the resolution for the optimization. If the predetermined value is set to a low value, more iterations of process 7 may be carried out, resulting a further optimized K. On the other hand, computational complexity may be reduced with a higher value of the predetermined value.

The process of FIG. 7 for optimizing the size of the data block may be summarized by a procedure that comprises: initializing a value of the size of the data block; iterating the step of generating the transmission schedule on the basis of the value of the size of the data block, estimating the success probability for the transmission schedule, and comparing with the threshold until the transmission schedule that meets the high-enough success probability is found. The amount of the redundancy information in the transmission schedule is increased with every iteration. In other words, the procedure of FIG. 4 is performed for the selected value of the size of the data block. In response to finding the transmission schedule that meets the high-enough success probability, the size of the data block is increased and the steps of generating the transmission schedule, estimating the success probability, and comparing with the threshold are re-iterated until the transmission schedule that meets the high-enough success probability is not found. On the other hand, in response to not finding the transmission schedule that meets the high-enough success probability, the size of the data block is decreased and the steps of generating the transmission schedule, estimating the success probability, and comparing with the threshold are re-iterated until the transmission schedule that meets the high-enough success probability is found. Upon finding a maximum value of the size of the data block that provides the high-enough success probability, the corresponding transmission schedule is transmitted to the receiver. In other words, the procedure of FIG. 6 changes the size of the data block in the binary search for the optimum value until the maximum size for the data block is found. With the procedure, the initial size of the data block converges towards the maximum size that still is deemed to meet the QoS requirement.

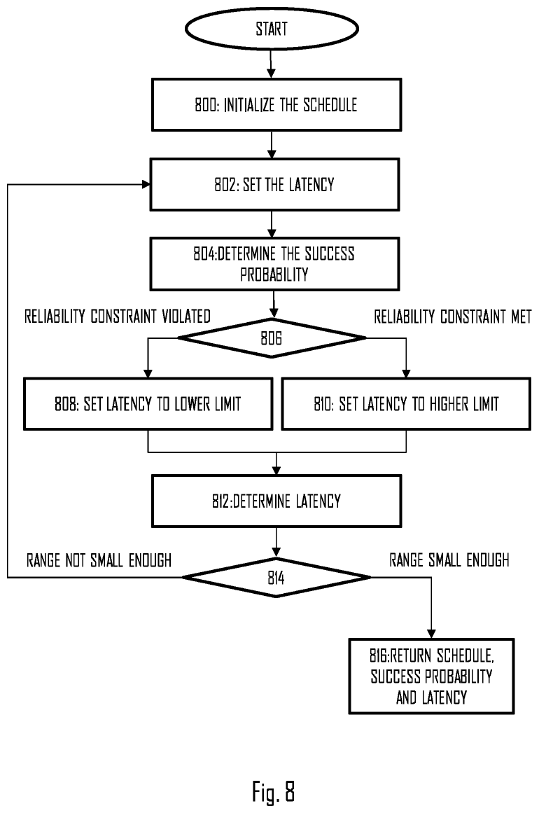

The optimization may be carried out for the other parameters as well. Referring to FIG. 8, the scheduler may find the optimal latency T so that the determined block size K and reliability R can be achieved. Since R is monotonically increasing as T increases, it is possible to use binary search as in the optimization of K. However, since the on-time delivery probabilities of the link paths change with T, this scheduler may re-run the iterative procedure for every latency value T. The scheduler starts the latency optimization with setting the minimum latency value Tₘᵢₙ to a minimum round-trip time value RTTₘᵢₙ and a maximum latency value Tₘₐₓ to a pre-determined maximum value, e.g. a maximum latency the application allows as defined in the QoS requirements. Then the scheduler sets the current latency value T to a value between Tₘᵢₙ and Tₘₐₓ, e.g. a mean value (block 800). After the T is set, the scheduler runs the process of FIG. 4 with current T, and R. The process may be run until all the link paths are full (block 802), as defined by the maximum delivery vector. By filling the link paths with the redundancy information, the lowest latency can be achieved. Then, the success probability P is computed (block 804). Based on the success probability, the scheduler makes a decision to set the Tₘᵢₙ or the Tₘₐₓ to the current T (block 806). If P is greater than or equal to R, the scheduler sets Tₘᵢₙ to the current T (block 808). In other words, higher latency can be tolerated. If P is smaller than R, the scheduler sets the Tₘₐₓ to the current T (block 810). In other words, the achievable latency was too high. After setting the new limits to the current T, scheduler determines a latency size range T_{Δ} (block 812). Then the scheduler compares T_{Δ} to a predetermined value and makes a decision (block 814). If the T_{Δ} is bigger than the predetermined value, the scheduler continues iterating by setting a new value of T to a value between the updated Tₘᵢₙ and Tₘₐₓ (block 702). If T_{Δ} is smaller or equal than the predetermined value, the scheduler returns the current T and, optionally, s and P (block 816).

The process of FIG. 8 may be summarized by a procedure for optimizing latency of the data block comprising: initializing a value of the latency requirement; estimating, on the basis of the performances and the value of the latency requirement, a maximum capacity of each link path; generating the transmission schedule for the data block by organizing the data block and the redundancy information to the link paths up to the maximum capacity of each link path; performing said estimating the success probability and said comparing and, in response to finding that the transmission schedule meets the high-enough success probability, increasing the value of the latency requirement and re-iterating said estimating the maximum capacity, generating, estimating the success probability, and comparing until the transmission schedule that meets the high-enough success probability is not found; in response to not finding the transmission schedule that meets the high-enough success probability, decreasing the value of the latency requirement and re-iterating said estimating the maximum capacity, generating, estimating the success probability, and comparing until the transmission schedule that meets the high-enough success probability is found; and upon finding a maximum value of the latency requirement that provides the high-enough success probability, using the corresponding transmission schedule in the transmission to the receiver.

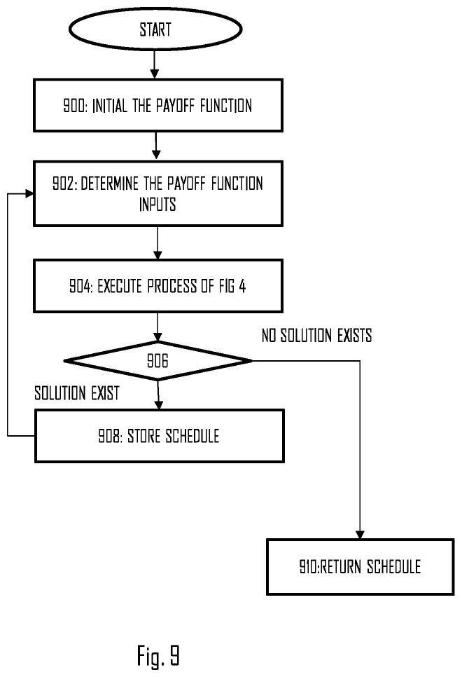

The processes described above may be used to optimize a single parameter R, K, or T. In an embodiment, joint optimization of multiple parameters may be carried out by using the process of FIG. 4. FIG. 9 illustrates such an embodiment. Referring to FIG. 9, the scheduler may also find a multi-objective schedule which iterates over two or three dimensions of the optimized parameters. The scheduler may optimize two or three of the following: reliability R, block size K or latency T. It may do this by keeping some of the parameters (if any) fixed. The main idea is that the application may define a payoff function f(R,K,T) that represents its optimization priorities: the protocol will then maximize the payoff function, providing the best solution for the needs of the application. An embodiment for such a combined optimization, where considering a flexible R and a flexible deadline T (fixed K) for a given payoff function f(R,T), starts with initializing a payoff variable F to the lowest value of the payoff function f(R,T) (block 900). The scheduler then executes the process of FIG. 4 (block 904) with the current values of R and T (determined in block 902) and attempts to find a schedule that meets R. If such a schedule can be found (block 906), the schedule and F may be stored (block 908). In the next iteration, the next value of F is taken from the payoff function (the second lowest one) in block 902, and the process of FIG. 4 is executed with the corresponding new values of R and T (block 904). Again, the schedule meeting the new R can be found, the new values of the schedule s and F are stored as the best solution so far. In this manner, the process continues with higher and higher values of the payoff function until R can no longer be met (block 906). Then, the best solution so far (value of s) is taken as the best schedule (block 910).

The process of FIG. 9 may be summarized by a procedure for jointly optimizing a plurality of parameters comprising: a size of the data block, latency of the data block, and a reliability requirement for the data block, the procedure comprising: defining a payoff function that is a function of the plurality of parameters; selecting values of the plurality of parameters that represent the smallest value of the payoff function and generating the transmission schedule for the data block by organizing, on the basis of the selected values of the plurality of parameter, the data block and the redundancy information to the link paths; performing said estimating the success probability and said comparing and, in response to finding that the transmission schedule meets the high-enough success probability, performing a re-selection where values of the plurality of parameters representing the next higher value of the payoff function are selected, and re-iterating said generating the transmission schedule, estimating the success probability, and comparing until the transmission schedule that meets the high-enough success probability is not found; and upon finding a maximum value of the payoff function that provides the high-enough success probability, and transmitting the data and redundancy information corresponding transmission schedule to the receiver.

A reason for sorting the values of the payoff function and starting the process from the lowest values is that the QoS requirements provided as variables in the payoff function may tighten as the value of the payoff function increases. Accordingly, the lowest value of the payoff function may be associated with the loosest QoS requirements, thus providing the most promising starting point for finding a scheduling solution that meets R.

FIGS. 7 to 9 thus describe embodiments for using the process of FIG. 4 for multiple different values of a parameter of the data block and optimizing the value of the parameter within constraints provided by the QoS requirements, e.g. the required reliability R.

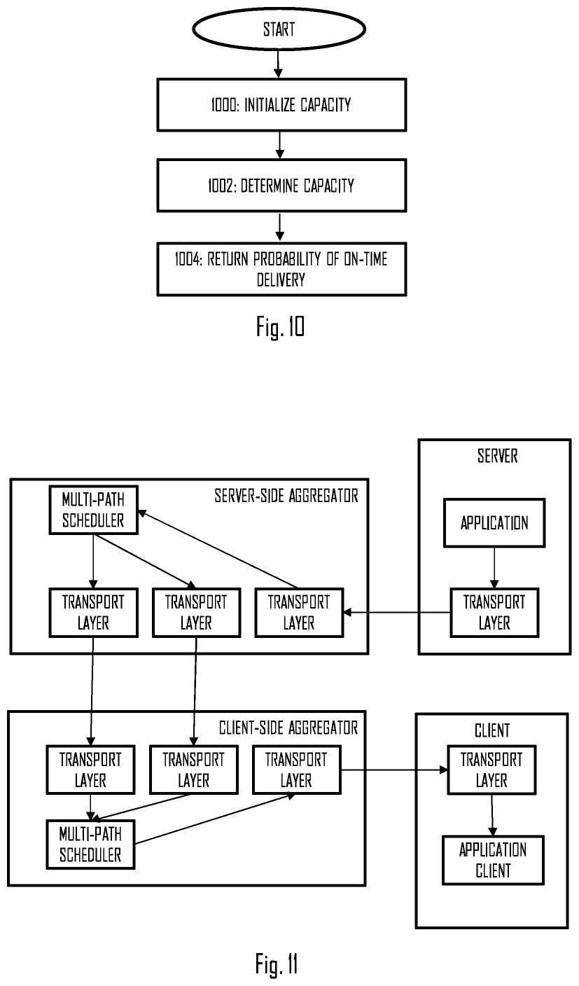

When computing the success probability P in block 418, for example, the link performances are taken into account. As described above, the link performances may take into account various parameters, such as at least one of the following: a number of packets queued in a transmission buffer of a link path, a delivery time of transmitted packets within a determined time window, an average queue time of a data packet in the transmission buffer, and a number of retransmissions needed to deliver a packet. FIG. 10 illustrates an embodiment for computing the success probability for a single link path I, that is Pᵢ(C) where C refers to a capacity of the link path. The capacity may be computed as follows. Assume that, at time tᵢ, there are i−1 packets in flight on a given link path, and the i^{th} packet is transmitted on the same link path. If we assume that packets are delivered in-order on that path, the i:th packet is delivered on time if the following conditions on the capacity of the path are verified:

$${C}_{ι} \geq \frac{{\sum }_{j = ι}^{i} {L}_{j}}{T - τ / 2 + {t}_{i} - {t}_{ι}} ∀ ι ∈ \{ 2 , … , i \} \qquad Eq . 1$$

$${C}_{1} \geq \frac{{\sum }_{j = 1}^{i} {L}_{j}}{T - τ / 2 + {t}_{i} - {t}_{1} - {q}_{1}} , \qquad Eq . 2$$

where tⱼ is the delivery time of packet j and Lⱼ is its length, τ is the minimum round-trip-time whereby a forward delay is assumed to be RTT/2, and q₁ is the transmission buffer queue measured for the latest acknowledged packet. Each condition considers the case in which the l:th packet experiences no queuing: in that case, all subsequent packets up to the i:th need to be delivered before the deadline. If all packets experience queuing, the second equation (Eq. 2) is used: the initial queue q₁ needs to be reduced so that the i:th packet will still be delivered in time. All these conditions need to be met in order for the packet to be delivered on time, so the minimum capacity for in order delivery is the largest value calculated above. The probability of on-time delivery is then easy to find using

pᵢ(dᵢ,qᵢ)=Pᵢ(max_{lϵ(1, . . . i)}Cᵢ) Eq.3

To implement the Eq1 to Eq3 in the scheduler, the scheduler first initializes the required capacity C to 0 (block 1000). Then it applies the Eq. 2. If the result C₁ is smaller than a required capacity C, scheduler sets the required capacity C to the C₁. Then the scheduler applies the Eq. 1 to all the remaining queued packets. If the scheduler finds that the Cᵢ is smaller than C, it sets C to Cᵢ. After the C has been calculated for all the packages (block 1002), the scheduler returns pᵢ(sᵢ,qᵢ), i.e. the probability of on-time delivery of the data packets currently scheduled to the link path i (block 1004).

Above, it has been described that the scheduling may be applied to multiple link paths established in a cellular communication system such as the 5G system. In such a case, the scheduler may operate on the PDCP layer or on a lower layer (e.g. MAC), for example. The scheduling principles may be applied to higher protocol layers as well, as illustrated in FIG. 11. FIG. 11 illustrates an example of an architecture for implementing the above-described scheduling. The arrows in FIG. 11 illustrate downlink transmission of the data block, the same architecture may be used for uplink in a straightforward manner. Referring to FIG. 11, the application server may output data to be transmitted to a client device. An application layer in the server may provide the data block to a transport layer that delivers the data block to an aggregator that manages the multi-path scheduling in a multi-path scheduler. The scheduler may operate on the transport layer and receive the transport layer data block from the server, perform the process of FIG. 3 or 4 and organize packets of the data block (payload and redundant information) to the multiple link paths (two in this example). Each packet may be provided with information enabling the client device to re-organize the packets received via the different link paths. The packets are then delivered to the client side via the link paths and aggregated on the transport layer before providing the aggregated data block to an application layer application executed in the client device.

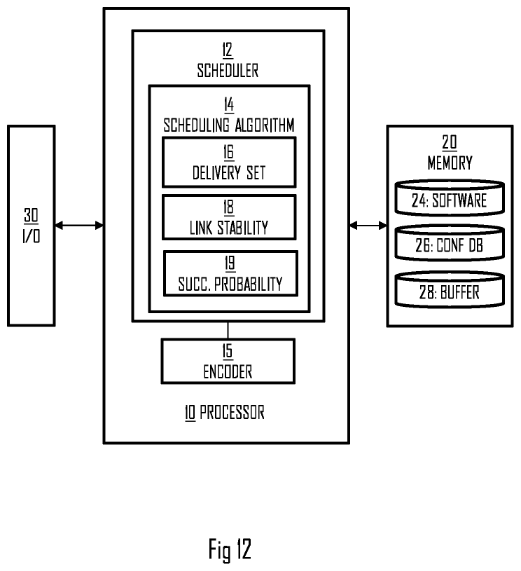

FIG. 12 illustrates an embodiment of a structure of the above-mentioned functionalities of an apparatus executing the functions in the process of FIG. 3 or any one of the embodiments described above for multipath scheduling. The apparatus illustrated in FIG. 11 may be comprised in the access node, the terminal device, in another network node of the cellular communication system, in a router device, in the application server, etc. In another embodiment, the apparatus carrying out the process of FIG. 3 or any one of its embodiments is comprised in such a device, e.g. the apparatus may comprise a circuitry, e.g. a chip, a chipset, a processor, a micro controller, or a combination of such circuitries in the device. The apparatus may be an electronic device comprising electronic circuitries for realizing some embodiments of the wireless device.

Referring to FIG. 12, the apparatus may comprise a communication interface 30 or a communication circuitry configured to provide the apparatus with capability for bidirectional communication with other network devices. Depending on the embodiment, the communication interface 30 may provide radio communication capability over multiple radio link paths (e.g. when the apparatus is in the terminal device), or it may provide communication capability over multiple link paths where each link path may include wired and/or wireless links. In some embodiments, the communication interface 30 is used for the communication with the cloud 114. The communication interface 30 may comprise standard well-known components such as an amplifier, a filter, and encoder/decoder circuitries for implementing the required communication capability.

The apparatus may further comprise a memory 20 storing one or more computer program products 24 configuring the operation of at least one processor 10 of the apparatus. The memory 20 may further store a configuration database 26 storing operational configurations of the apparatus, e.g. the QoS requirements, the schedules, the link performances, etc.

The apparatus may further comprise the at least one processor 10 configured to control the execution of the process of FIG. 3 or any one of its embodiments, e.g. the process of FIG. 4. The processor 10 may comprise an encoder circuitry 15 configured to encode the data block into one or a plurality of packets to be transmitted to the data sink device. The packets may include payload packets and packets carrying the redundant information. In an embodiment, the encoder encodes the data block by using rateless codes in which case the packets may carry the payload data in an encoded form. The processor may further comprise the above-described scheduler 12 configured to perform the scheduling of the packets into the multiple link paths. The scheduler may implement a scheduling algorithm 14, e.g. the process of FIG. 4. The scheduling algorithm may call other modules of the processor during the execution. The other modules may include a delivery set computation module 16, a link stability computation module 18, and a success probability computation module 19. The delivery set computation module may execute the process of FIG. 6, the link stability computation module may execute the process of FIG. 5, and the success probability computation module 19 may execute the process of FIG. 10. In some embodiments, the scheduler 12 is configured to optimize the schedule in view of the reliability only, as described in connection with FIG. 4. In other embodiments, the scheduler may perform the scheduling in an attempt to optimize one or more QoS parameters, as described above in connection with FIGS. 7 to 9.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention. The processes or methods described in FIGS. 3 to 10 may also be carried out in the form of one or more computer processes defined by one or more computer programs. A separate computer program may be provided in one or more apparatuses that execute functions of the processes described in connection with the Figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1-18. (canceled)

19. An apparatus comprising means for performing:
receiving a data block to be transmitted to a receiver apparatus via multiple link paths;
associating a quality of service requirement with the data block;
determining performance of each of the multiple link paths;
encoding redundancy information from the data block and scaling an amount of the redundancy information based at least partially on the quality of service requirement and the determined performances;
organizing, based at least partially on the quality of service requirement and the determined performances, the data block and the redundancy information to the multiple link paths; and
transmitting the data block and the redundancy information to the receiver apparatus via the multiple link paths.

20. The apparatus of claim 19, wherein the means are configured to partition the data block into a plurality of data packets, and to organize the plurality of data packets into the multiple link paths, based at least partially on the quality of service requirement and the determined performances.

21. The apparatus of claim 19, wherein the means are configured to determine the performance of a link path by estimating a delivery time for the data block over the link path.

22. The apparatus of claim 21, wherein said estimation of the delivery time comprises at least one of estimation of the link path capacity, a number of queued packets on the link path, and a link path end-to-end delay.

23. The apparatus of claim 19, wherein the means are configured to determine a success probability corresponding to a probability of a successful data block transmission over the multiple link paths and to organize the redundancy information to the multiple link paths until the success probability is achieved, wherein the success probability is computed on the basis of the determined performances.

24. The apparatus of claim 19, wherein the means are configured to determine a stability limit for each link path, where said stability limit sets a maximum amount of data and/or redundancy information that can be organized in the link path, and to organize the redundancy information to the multiple link paths until the stability limit is reached.

25. The apparatus of claim 19, wherein the means are configured to perform said organizing for multiple different values of a parameter of the data block and to optimize the value of the parameter within constraints provided by the quality-of-service requirements.

26. The apparatus of claim 25, wherein the parameter is one of a size of the data block and latency of the data block.

27. The apparatus according to claim 19, wherein the means comprise:
at least one processor; and
at least one memory including computer program code, said at least one memory and computer program code being configured to, with said at least one processor, cause the performance of the apparatus.

28. A method comprising:
receiving, by a network node, a data block to be transmitted to a receiver apparatus via multiple link paths;
associating, by the network node, a quality of service requirement with the data block;
determining, by the network node, performance of each of the multiple link paths;
encoding, by the network node, redundancy information from the data block and scaling an amount of the redundancy information based at least partially on the quality of service requirement and the determined performances;
organizing, by the network node, based at least partially on the quality of service requirement and the determined performances, the data block and the redundancy information to the multiple link paths; and
transmitting, by the network node, the data block and the redundancy information to the receiver apparatus via the multiple link paths.

29. The method of claim 28, wherein the network node partitions the data block into a plurality of data packets and organizes the plurality of data packets into the multiple link paths, based at least partially on the quality of service requirement and the determined performances.

30. The method of claim 28, wherein the network node determines the performance of a link path by estimating a delivery time for the data block over the link path.

31. The method of claim 30, wherein said estimation of the delivery time comprises at least one of estimation of the link path capacity, a number of queued packets on the link path, and a link path end-to-end delay.

32. The method of claim 28, wherein the network node determines a success probability corresponding to a probability of a successful data block transmission over the multiple link paths and organizes the redundancy information to the multiple link paths until the success probability is achieved, wherein the success probability is computed on the basis of the determined performances.

33. The method of claim 28, wherein the network node determines a stability limit for each link path, where said stability limit sets a maximum amount of data and/or redundancy information that can be organized in the link path, and to organize the redundancy information to the multiple link paths until the stability limit is reached.

34. The method of claim 28, wherein the network node performs said organizing for multiple different values of a parameter of the data block and optimizes the value of the parameter within constraints provided by the quality-of-service requirements.
